(19) United States
(12) Patent Application Publication
(10) Pub. No.: US 2005/0120010 A1
(43) Pub. Date: Jun. 2, 2005

(54) System and method for determining costs within an enterprise

(75) Inventors: Michael L. Philpott, Seymour, IL (US); Eric A. Hiller, Waltham, MA (US); R. Sebastian Schrader, Ayer, MA (US); Jeremy D. Rishel, Boston, MA (US); Andrew J. Carroll, Arlington, MA (US); Frank V. Azzolino, Acton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: aPriori Technologies, Inc., Concord, MA (US)

(21) Appl. No.: 10/993,405

(22) Filed: Nov. 19, 2004

Related U.S. Application Data
(60) Provisional application No. 60/523,746, filed on Nov. 20, 2003.
(60) Provisional application No. 60/525,699, filed on Nov. 28, 2003.

(51) Int. Cl. G06F 17/30

(52) U.S. Cl. 707/3

(57) ABSTRACT

In accordance with an embodiment of the invention, there is disclosed a method for determining costs within an enterprise. The method comprises determining a set of cost-drivers based on characteristics of three-dimensional design data of a manufacturable component; and providing, to a plurality of different enterprise functions, database access to cost data from any combination of: the set of cost-drivers, and a set of costs determined based on the set of cost-drivers. In another embodiment, there is disclosed a computer system for determining costs within an enterprise. The system comprises a database comprising a set of stored cost-drivers determined based on characteristics of three-dimensional design data of a manufacturable component; and a network capable of providing, to a plurality of different enterprise functions, access to cost data from any combination of: the set of cost drivers, and a set of costs determined based on the set of cost-drivers.

### RELATED APPLICATIONS

This application claims the benefit of U.S. Provisional Application No. 60/523,746, filed on Nov. 20, 2003, entitled “Integrated Real-Time Feature Based Costing,” and of U.S. Provisional Application No. 60/525,699, filed on Nov. 28, 2003, entitled “Enterprise Implementation and Customization of Feature Based Costing.” The entire teachings of the above applications are incorporated herein by reference. This application also relates to subject matter contained in U.S. Patent Application Ser. No. ______ filed on Nov. 19, 2004, entitled “Integrated Real-Time Feature Based Costing,” and bearing Attorney Docket No. 2895/107 and University of Illinois Case No. TF03061, the entire teachings of which are also hereby incorporated herein by reference.

### BACKGROUND OF THE INVENTION

When a business enterprise designs and manufactures a product that includes a large number of manufactured parts, it needs to ensure that the cost of producing the product does not exceed a target cost. Otherwise, the enterprise may, for example, come to the end of a three-year cycle of designing a machine that contains over ten thousand parts; only to discover that the cost of producing the machine as it is designed is far greater than the customer is willing to pay for it. Therefore, in order to estimate costs during the design of a product, enterprises currently use many different specialized techniques.

In some large enterprises, there is a central costs department. A designer who is designing a manufactured part may consult the costs department to determine the estimated cost of manufacturing the part. The designer may also consult a local cost engineer, who works alongside the designer. Alternatively, designers may call upon manufacturing engineers to advise on the cost of using different manufacturing techniques.

Periodically, however, (for example, every six months), management of a large enterprise typically desires to determine whether the designed costs of a given project are on target for the project's budget. The resulting rush to determine costs can consume a significant amount of product development time.

A variety of different software products have been used to facilitate various phases of product design and business management in large enterprises.

To help manage product design, enterprises may use Product Life-Cycle Management (PLM) or Product Data Management (PDM) software. Such systems may organize various records of product revisions and engineering changes, including test data, CAD data, and bills of materials.

In order to assist with financial records, enterprises often use Engineering Resource Planning (ERP) systems, which manage financial records, human resources information, and other aspects of engineering projects.

Most enterprises today use a variety of in-house techniques to determine costs, such as database or spreadsheet systems that allocate costs according to Activity Based Costing (ABC) principles. A number of commercial systems are also available that use ABC principles, such as Starn, ABC Tools, Net Prophet, and Activity Analyzer. ABC-based cost estimates are determined by routing parts through the production system and attempting to determine the actual cost of manufacture. Using this approach to estimate costs is time consuming and, without actually producing the parts, inaccurate.

Other commercial cost estimating systems, such as Boothroyd and Dewhurst (www.dfma.com) and Cognition (www.cognition.com) use process-driven models, which use industry averages to estimate processing times and costs. Another commercial cost estimating system, Galorath's SEER, uses parametric component-based cost estimating approaches, based on historical cost information of similar parts. This method is only applicable to a specific kind of part (e.g. a missile tube or an air foil), but cannot be readily used by designers working on new or significantly different components.

A variety of systems are also available for providing comparative data on purchasing components from manufacturers outside an enterprise. In the construction industry, such data has been used to estimate costs of an entire assembled construction project. Similarly, systems are available that can determine the optimum order of assembling a large number of manufactured components, based on known costs of joining the parts together.

### SUMMARY OF THE INVENTION

In accordance with an embodiment of the invention, there is disclosed a method for determining costs within an enterprise. The method comprises determining a set of cost-drivers based on characteristics of three-dimensional design data of a manufacturable component; and providing, to a plurality of different enterprise functions, database access to cost data from any combination of: the set of cost-drivers, and a set of costs determined based on the set of cost-drivers.

In further related embodiments, providing the database access may be performed during product development of a newly designed manufacturable component. The plurality of different enterprise functions may comprise a design function, a manufacturing function, a purchasing function, and a business management function. Providing the database access may comprise providing a plurality of different cost-levels, which may be selected from a design cost, a manufacturing cost, and a purchasing cost. The manufacturing cost may comprise a cost determined based on costs of routing production of the manufacturable component to a specific manufacturing station. The purchasing cost may comprise a cost selected from purchasing costs for a plurality of different manufacturing plants.

In other related embodiments, the cost-drivers may be stored in a database in association with three-dimensional computer-aided design data for the manufacturable component, or independent of the three-dimensional computer-aided design data for the manufacturable component. Providing the database access may be used to perform a should-cost analysis for a design project comprising a plurality of manufacturable components. A cost estimation cycle may be initiated with each design change in the three-dimensional design data of the manufacturable component; and the set of cost drivers may be determined using a geometric feature extraction algorithm. The method may further comprise determining a set of acceptable manufacturing process routings for the manufacturable component; determining a lowest cost routing, of the set of acceptable routings; and displaying the lowest cost routing to a user on a graphical user interface.

In further related embodiments, a method comprises using a first server to store the cost data; and using a second server to store a set of cost models from which the cost drivers are determined. The method may also comprise providing different levels of security access to the cost data, to different enterprise functions, the levels of security access comprising modify access and read-only access. In addition, an interpreter may be provided to allow a user to link cost drivers to custom cost models, which are used to determine the costs based on the cost drivers. The interpreter may use a scripting language to link the cost drivers to the custom cost models. There may also be provided a comparison of tooling investments for producing the manufacturable component based on the cost data. A representation of the set of cost-drivers may be graphically superimposed onto the three-dimensional design data. The method may further comprise providing a manufacturing cost for an assembly of a plurality of manufacturable components, wherein the manufacturing cost for each manufacturable component of the assembly is determined using cost-drivers based on three-dimensional design data of each such manufacturable component. In addition, providing the database access may comprise providing cost data, to at least some of the plurality of different enterprise functions, that is based on manufacturing attributes specified without direct reference to a geometric model of the manufacturable component.

In another embodiment according to the invention, there is provided a computer system for determining costs within an enterprise. The system comprises a database comprising a set of stored cost-drivers determined based on characteristics of three-dimensional design data of a manufacturable component; and a network capable of providing, to a plurality of different enterprise functions, access to cost data from any combination of: the set of cost drivers, and a set of costs determined based on the set of cost-drivers.

In further related embodiments, the system may comprise a design interface, for providing the database access to a design function; a manufacturing interface, for providing the database access to a manufacturing function; a purchasing interface, for providing the database access to a purchasing function; and a management interface, for providing the database access to a business management function. The system may also comprise a customization interface, for allowing a user to determine cost data based on costs of routing production of the manufacturable component to one of a plurality of different manufacturing plants. The manufacturing interface may allow a user to determine a cost based on costs of routing production of the manufacturable component to a specific manufacturing station. The purchasing interface may be capable of providing a should-cost analysis for a design project comprising a plurality of manufacturable components.

In other related embodiments, the database may comprise three-dimensional computer-aided design data for the manufacturable component, stored in association with the cost drivers, or stored independent from the cost drivers. The system may also comprise a process optimizer capable of initiating a cost estimation cycle with each design change in the three-dimensional design data of the manufacturable component. The process optimizer may be capable of determining the set of cost drivers using a geometric feature extraction algorithm. The process optimizer may also be capable of determining a set of acceptable manufacturing process routings for the manufacturable component; determining a lowest cost routing, of the set of acceptable routings; and providing the lowest cost routing to a graphical user interface for display to a user.

In further related embodiments, the system may comprise a first server for storing the cost data; and a second server for storing a set of cost models from which the cost drivers are determined. The system may also comprise an interpreter capable of allowing a user to link cost drivers to custom cost models, which are used to determine the costs based on the cost drivers. An assembly module may provide a manufacturing cost for an assembly of a plurality of manufacturable components, wherein the manufacturing cost for each manufacturable component of the assembly is determined using cost-drivers based on three-dimensional design data of each such manufacturable component. Also, the network may be capable of providing access to the cost data, to at least some of the plurality of different enterprise functions, based on manufacturing attributes specified without direct reference to a geometric model of the manufacturable component.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram summarizing operation of a system for enterprise-wide determination of costs, according to an embodiment of the invention.

FIG. 2 is a block diagram summarizing components of a costing system in accordance with an embodiment of the invention.

FIG. 3 is a block diagram illustrating the use of a costing system within an enterprise, in accordance with an embodiment of the invention.

FIG. 4 shows a costing window displayed during a CAD design session, in accordance with an embodiment of the invention.

FIG. 5 shows a screen display of a cycle time window, selectable from a dialog box of the embodiment of FIG. 4, in accordance with an embodiment of the invention.

FIG. 6 shows a screen display of a Cost Detail window, selectable from a dialog box of the embodiment of FIG. 4, in accordance with an embodiment of the invention.

FIG. 7 shows a screen display of a Tooling Cost window, selectable from a dialog box of the embodiment of FIG. 4, in accordance with an embodiment of the invention.

FIG. 8 shows a screen display of a Cost Drivers window, selectable from a dialog box of the embodiment of FIG. 4, in accordance with an embodiment of the invention.

FIG. 9 shows a screen display of a Properties window, selectable from a dialog box of the embodiment of FIG. 4, in accordance with an embodiment of the invention.

FIG. 10 shows a screen display of a stock material list, accessible through a Help screen, in accordance with an embodiment of the invention.

FIG. 11 shows a view of a Cost Summary window of the embodiment of FIG. 4, following a change to estimated production volume, in accordance with an embodiment of the invention.

FIG. 12 is a window showing the result of increasing the bend radius of a bracket, in accordance with an embodiment of the invention.

FIG. 13 shows the graphical superposition of tool path cost drivers, selected by a cost optimization algorithm, onto a CAD model, in accordance with an embodiment of the invention.

FIG. 14 shows a user interface dialog box for a multiple part mode of operation, called Batch Mode, in accordance with an embodiment of the invention.

FIG. 15 is a screen display illustrating use of an assembly mode of operation, in accordance with an embodiment of the invention.

FIG. 16 shows a Cost Summary window within an assembly mode dialog box, in accordance with an embodiment of the invention.

FIG. 17 shows a system administrator interface, according to an embodiment of the invention.

FIG. 18 shows a user interface for defining process routings, in accordance with an embodiment of the invention.

FIG. 19 shows a Custom Process Modeler, according to an embodiment of the invention.

FIG. 20 shows an interface for a manufacturing function of an enterprise, in accordance with an embodiment of the invention.

FIG. 21 is a block diagram summarizing components of an embodiment according to the invention that includes an enterprise client subsystem.

### DETAILED DESCRIPTION OF THE INVENTION

The present invention is based on the insight that existing techniques for determining cost cannot rapidly determine the estimated cost of a product under development that includes a large number of manufacturable components of an enterprise's own new design; and cannot make such cost information accessible to, and modifiable by, many different functions within the enterprise.

A description of preferred embodiments of the invention follows.

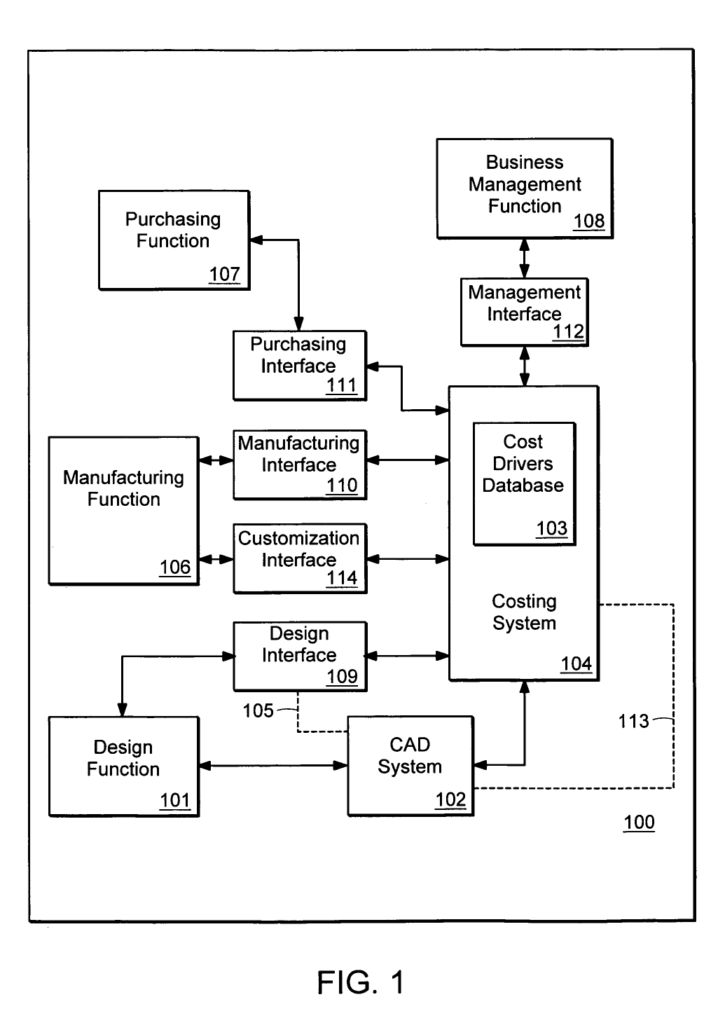

FIG. 1 is a block diagram summarizing operation of a system for enterprise-wide determination of costs, according to an embodiment of the invention. In this embodiment, a design function 101 within an enterprise 100 uses a three-dimensional computer-aided design (CAD) system 102 to design a new manufacturable component. The design function 101 uses a design interface 109 of a costing system 104, in real time, to determine the most cost-effective method of producing the new manufacturable component. The system 104 may be used feature by feature, as the design function 101 designs the part; and cost estimates can be automatically computed within a second or two. The design interface 109 may either be integrated into CAD system 102, or associated with it via link 105, or part of an entirely separate system. By automatically analyzing the geometry and other characteristics of the manufacturable component, the costing system 104 determines a set of cost drivers for the manufacturable component, and stores them in a cost driver database 103. The cost drivers are variables that the costing system 104 uses in mathematical equations to determine the cost of manufacturing the component; for example, the cost drivers might include the number of small holes and bends in the component, or the perimeter of the component. Once the costing system 104 determines the cost of the component, it provides the cost to the design function 101 via the design interface 109; and may also make the cost drivers themselves available to the design function 101. The design function 101 thus can make use of estimated manufacturing costs during the design process.

In contrast to prior systems, the embodiment of FIG. 1 also makes the product's costs, initially determined based on the cost-drivers for the component, available to many different functions across the enterprise 100. For example, a manufacturing function 106, which may include manufacturing engineers or cost engineers, may update the cost drivers database 103 using a manufacturing interface 110 that supports the selection of specific work center information, such as overhead rates and labor rates for a given manufacturing station or plant. The design-level cost, initially provided to design function 101 based on the geometric feature analysis, may therefore be revised into a manufacturing-level cost that reflects the actual cost of manufacture. Similarly, a purchasing or supply-management function 107 may access the costing system 104 via a purchasing interface 111 that supports various analyses to aid in purchasing decisions, such as “should-cost” analyses and request for quote activities; so that the product cost is further refined into a purchasing-level cost.

In addition, a business management function 108, which may include accounting and finance, is able to access the costing system 104, via management interface 112. Thus, management of the enterprise 100 can, for example, quickly assess the current estimated cost to produce a product that is being developed, to see whether the project is within budget. Finally, the manufacturing function 106—for example, here, a skilled manufacturing or cost engineer—can use a customization interface 114 to efficiently tailor the system 104 to the needs and specifications of the company, and to accommodate differences in manufacturing and business systems, as will be described further below.

In this way, the embodiment of FIG. 1 provides a seamless integration of cost throughout the enterprise, encompassing the whole product life cycle from concept to disposal. It provides the enterprise with a fully integrated part and assembly model specification that contains embedded cost information that may be accessed and updated, all the way from design conception to manufacture, service, and disposal of the product. By contrast with existing systems, which are function-specific, the embodiment of FIG. 1 provides a cost system that can be accessed by any function within the enterprise 100.

It should be noted that the CAD system 102 may be, but need not be, integrated with the costing system 104; or may share some data with it, as indicated by link 113. It addition, it should be appreciated that system 104 need not be implemented as a single system, but could also reside on many separate servers; and that the cost drivers database 103 may be divided into many separate databases. Furthermore, cost-drivers may be stored in a database in association with three-dimensional design data for a manufacturable component; or may instead be stored independently of the three-dimensional design data.

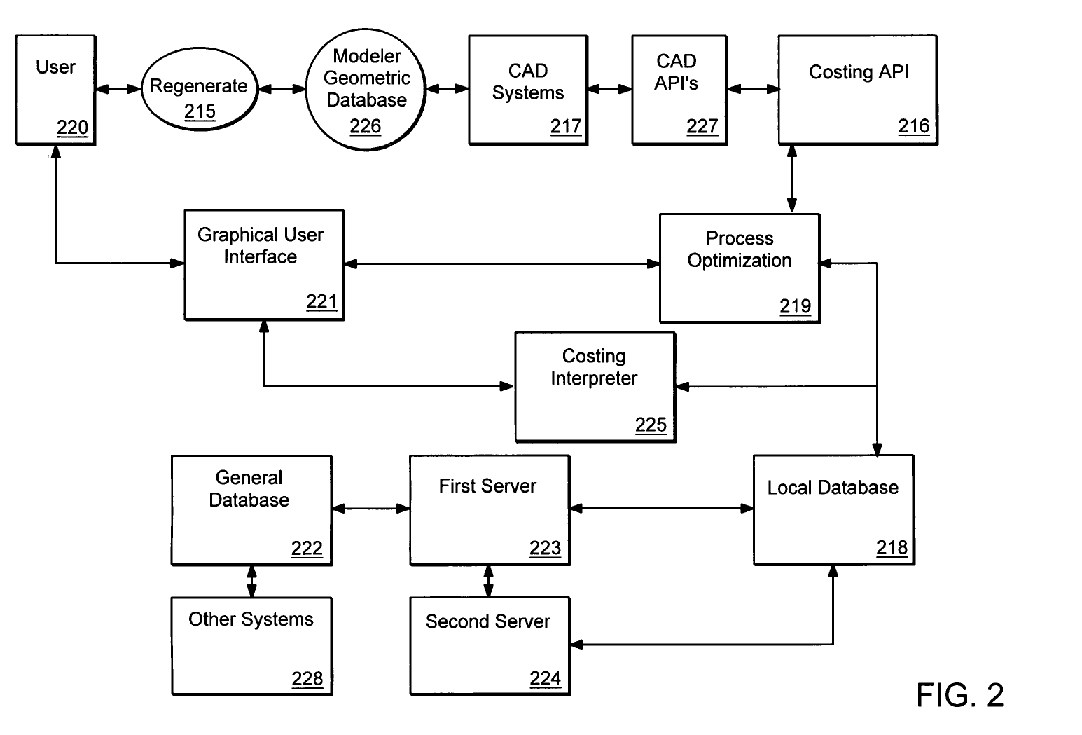

FIG. 2 is a block diagram summarizing components of a costing system in accordance with an embodiment of the invention. When a user 220 of the system designs a part using a CAD system, each change to the part's geometry requires the CAD system to regenerate 215 the part's geometry, using a modeler geometric database 226. In the embodiment of FIG. 2, each regeneration cycle 215 initiates a new cost estimation cycle. A costing application interface (API) 216 uses a number of geometric feature extraction routines to extract manufacturing features, which have been identified as primary cost drivers, from the part's geometry; such as the number of small holes or bends in the part. The costing API 216 includes a conversion process that allows it to interact with a number of independent proprietary CAD systems 217, via their CAD application interfaces (API's) 227. The independent CAD systems 217 may include, for example, ProEngineer, Catia, Solidworks, UG/SDRC NX and Autodesk Inventor. The costing API 216 uses the CAD systems' API's 227 to provide high speed of operation, but does not disturb the process of CAD design using these systems.

The costing API 216 uses feature extraction routines to mathematically manipulate the features of the part, to determine the presence and number of feature cost drivers. The cost drivers are variables for the process cost models, which are mathematical equations used by a costing process optimizer 219. The optimizer 219 determines machine cycle times, and operator times for performing miscellaneous tasks, such as loading and unloading processing machines. The optimizer 219 converts these times to costs using company-specific data, such as labor rates, machine depreciation rates, and overhead rates, extracted from a costing local database 218. The local database 218 contains cost models, machine information, process routings, and raw material data. The optimizer 219 uses the local database 218 to determine acceptable process routings that may be used to manufacture the part; determines the sequence of processes that offers the lowest cost solution; and returns the lowest cost routing to the user 220 via a graphical user interface 221. The design cycle may then be repeated, following either design change or iteration.

In order to calculate the lowest cost process routing, the optimizer 219 may sequentially analyze all possible routings to determine the lowest cost; or, if large combinatorial effects would produce excessive computation times, the optimizer 219 may use genetic algorithms, or other appropriate optimization techniques, to find a near-optimum solution.

Because the embodiment of FIG. 2 uses company-specific information to determine costs, unlike existing systems that rely on industry averages, the embodiment of FIG. 2 uses two servers 223 and 224 to provide various levels of secure access to the cost database. A first tier of users is given full control over the cost database, including the ability to modify, read and execute, read, write, and access the cost databases 218 and 222. A second tier of users is given only the ability to read and access the databases 218 and 222; and a third tier of users is given read-only access. In order to implement the levels of secure access to the data, the second server 224 stores only the output part information of the local database 218, such as cost estimates, manufacturing optimizations, and cost drivers; while the first server 223 stores the input information of the local database 218, which may be updated by various users, such as supplier information, cost models, machine specifications, material information, work center rates, and process routings. A general database 222 includes both the output part information and the input information, and links to other systems 228, such as Standards, Parts Catalogs, ERP systems, PLM systems, or other systems.

The embodiment of FIG. 2 also includes a costing interpreter 225, which allows a cost expert or other employee of an enterprise to create and store custom cost models, and company standard times and costs, in the local database 218. To do so, the interpreter 225 allows a user 220 to use a scripting language to link feature-extraction variables to the custom cost models. The custom cost models describe specific configurations of equipment and specific activities of machine operators, which differ greatly between different enterprises. In this way, the embodiment of FIG. 2 allows an enterprise to obtain accurate, company-specific cost estimates in real time.

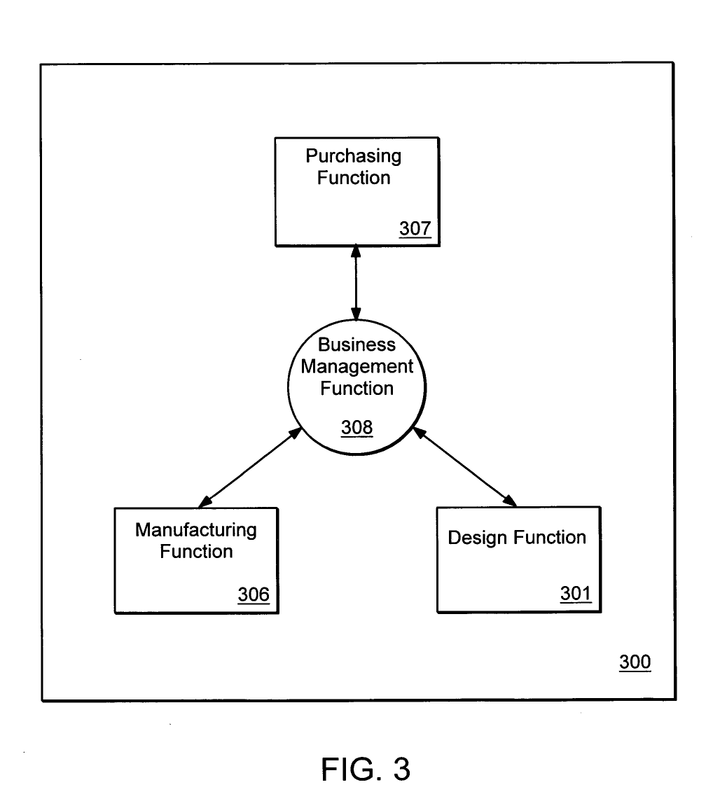

FIG. 3 is a block diagram illustrating the use of a costing system within an enterprise, in accordance with an embodiment of the invention. Using similar reference numbers to those of FIG. 1, the enterprise 300 includes a design function 301, a manufacturing function 306, and a purchasing function 307; and, at the core of the enterprise, a business management function 308.

A costing system according to an embodiment of the invention is useful to all of these functions 301, 306, 307, and 308.

The costing system may be used by the design function 301 to provide: real time cost estimating, feature by feature, as a part model is designed on a CAD system; “what-if” design trade-off analysis, so that different design concepts may be compared and evaluated; soft versus hard tooling decisions that help determine how the structure of the design may be most cost-effectively configured; and the ability to rapidly evaluate alternative materials, and their associated processing alternatives.

A system according to an embodiment of the invention may be used by the manufacturing function 306 to convert cost estimates during design to actual costs of production; to make routing decisions on the production floor; to define routings and processes through a custom process model interface; and to provide supervisory level control of the costing system.

The purchasing function 307 may use a costing system according to an embodiment of the invention to make purchasing decisions, such as: to compare costs of manufacturing in-house versus purchasing outside the enterprise (make-buy decisions); to perform “should-cost” analyses, to aid in supplier negotiations; to automatically prepare request-for-quote (RFQ) documents, including automatic quoting as a supplier to a higher tier, as well as purchasing decisions to a lower tier; and to provide administrator access to create supplier cost models.

Finally, the business management function 308 can use a costing system according to an embodiment of the invention to obtain timely roll-up cost information, particularly during the product development cycle. A management interface of the system provides the business management function 308 with access to costs and times, and three-dimensional viewing access to parts for validation, sales, marketing, and other purposes.

Thus, as illustrated by FIG. 3, an embodiment according to the invention makes available, to users throughout an enterprise, all information generated in each function of the enterprise related to a given component. Information relating to the component is maintained or otherwise accumulated beginning with the concept phase, through the purchasing phase, and through the manufacturing phase. Estimates are continually refined from early, fairly accurate estimates, through to production level costs. Cost control becomes much improved, because all parts of the enterprise have access to cost information as soon as it is created or modified.

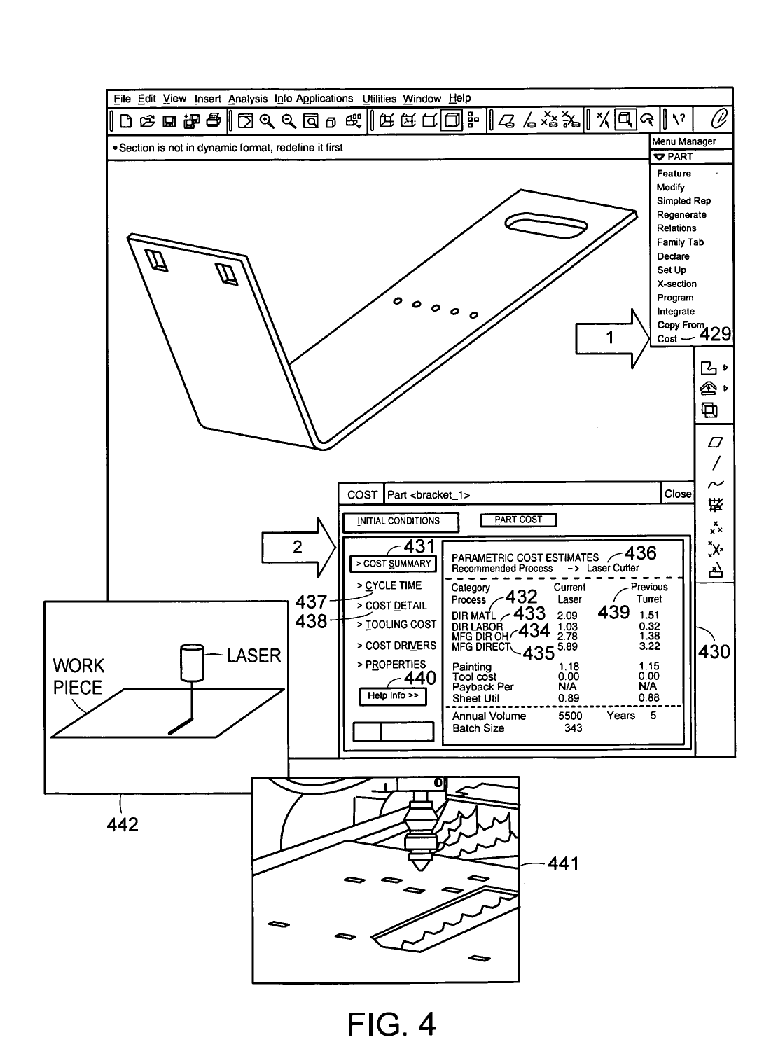

FIGS. 4-20 show screen displays that illustrate components and functionality of a costing system according to an embodiment of the invention.

FIG. 4 shows a costing window displayed during a CAD design session, in accordance with an embodiment of the invention. In the screen display of FIG. 4, a small sheet metal bracket is being designed using a proprietary CAD system (Parametric Technology's ProEngineer v2001) with a costing system according to an embodiment of the invention installed and fully integrated. At any time during the design of a part, the manufacturing cost is calculated and displayed by clicking on “Cost” 429 in the Menu Manager dialog box (1). The costing dialog box 430 appears (2), and the cost is automatically calculated and presented to the user within a second or two. Once initiated, the costing dialog box 430 remains open and is automatically updated each time a change to the model is made and a regeneration occurs. The costing dialog box 430 is the primary dialog box of the design function portion of the graphical user interface of an embodiment according to the invention, and provides access to further design function dialog boxes.

In FIG. 4, the costing dialog box 430 displays a Cost Summary window, as selected by tab 431. The Cost Summary window shows the new or current cost in dollars per part and identifies the recommended process routing. As shown in this example, the material cost 432 is $2.09, the direct labor cost 433 is $1.03, the direct overhead cost 434 is $2.78 and the total cost, or manufacturing direct 435, is $5.89. The recommended process is identified as “Laser Cutter” 436. This is actually an abbreviation for a complete routing which is shown in more detail in the Cycle Time 437 and Cost Detail 438 dialog boxes. FIG. 4 also shows the “Previous” cost 439 of material, labor, overhead, etc. This is the cost previous to the last regeneration or change to the part. In this example, the thickness of the part has been changed from 4 mm thick to 6 mm thick. At 4 mm thick, the costing software had recommended 439 a turret press based process routing. As can be seen, the increased thickness to 6 mm resulted not only in a material cost 432 increase from $1.51 to $2.09 but also a significant labor cost 433 increase from $0.32 to $1.03. The total increase in cost 435 from $3.22 to $5.89 is unexpectedly high, almost double. This is because turret presses are higher speed blanking machines than laser cutters, but are only suitable for thinner gauge materials. Thus, it can be seen that the embodiment of FIG. 4 assists a designer to find the optimum routing to produce a given design, as design features are changed. Each time the model is regenerated, the analysis is automatically repeated. An embodiment according to the invention extracts cost drivers, applies mechanistic process models, computes all possible process routings, and rapidly presents new costs to the user. The user may select the lowest cost option to be displayed or may select a specific process routing.

The “Help info” button 440 of the embodiment of FIG. 4 provides information about processes and routings. Manufacturing processes are described through the use of a multi-media presentation. Video clips 441 and animations 442 explain each manufacturing process, including important design-for-manufacture considerations, such as geometry that is difficult or particularly expensive. Thus, in accordance with the embodiment of FIG. 4, a user of the system undergoes a continuous education process, which is partly a natural process of learning from witnessing the cost of parts change as each feature is added to the model. Further and more detailed process knowledge is provided by the help files 440-442. An embodiment according to the invention therefore adds to the continuous enhancement of cost knowledge over time as the system is used within an enterprise.

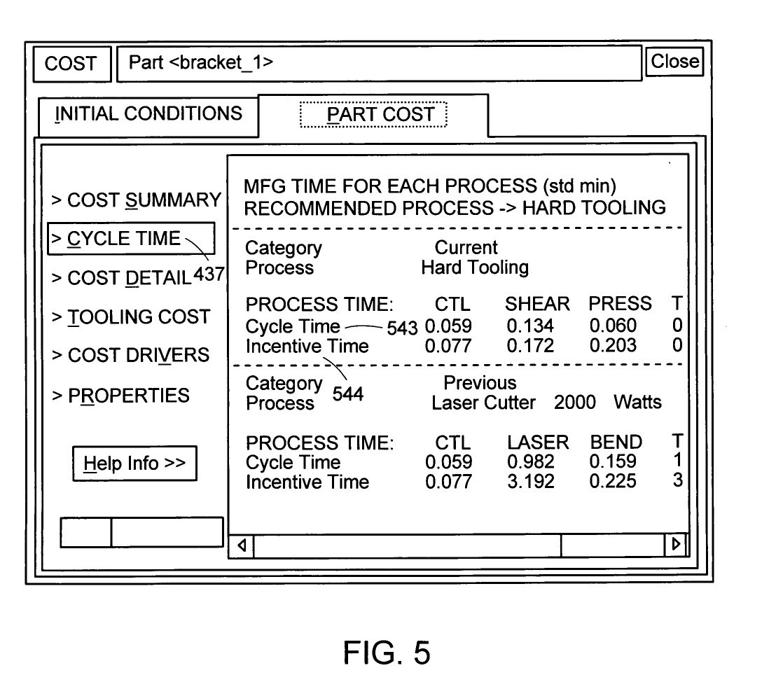

Other information is available through tabs and buttons on the costing dialog box 430. FIGS. 5-9 show screen displays of windows selectable from the costing dialog box 430, in accordance with an embodiment of the invention.

FIG. 5 shows a screen display of the cycle time window, selectable from the costing dialog box 430 of FIG. 4, in accordance with an embodiment of the invention. The cycle time window 437 shows times in minutes for each machine in the process routing for the current and previous regeneration. Cycle Time 543 is the time in minutes that the machine takes to complete one part. Incentive Time 544 is the operator labor time allowance in minutes. Incentive time 544 takes into account tending/operating the machine while cycling, loading and unloading the machine; and other miscellaneous activities required of the operator, such as cleaning, deburring, stacking parts, etc.

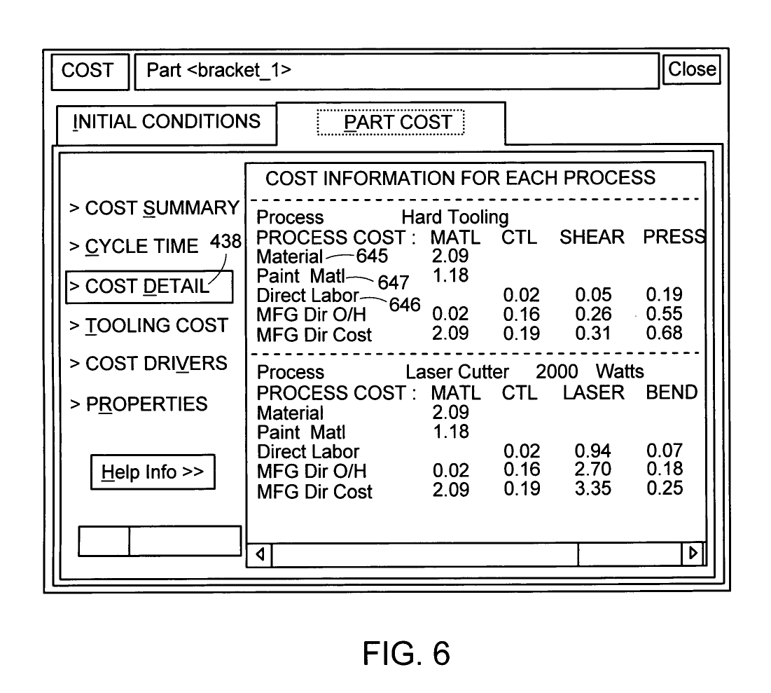

FIG. 6 shows a screen display of the Cost Detail window 438, selectable from the costing dialog box 430 of FIG. 4, in accordance with an embodiment of the invention. The Cost Detail window of FIG. 6 displays the cost in dollars per part for each machine in the process routing. These costs are calculated from the cycle time and machine time information. Material cost 645 is calculated by determining the total number of parts that may be nested on a standard sheet of stock material. An embodiment according to the invention optimizes this to achieve high sheet utilization and lowest material cost. Direct Labor 646 is the operator cost for each machine or process. It is calculated by multiplying the Incentive time 544 by the labor rate, which is dependent on the labor grade for specific machines. Cost to paint the part 647 is also provided in this window.

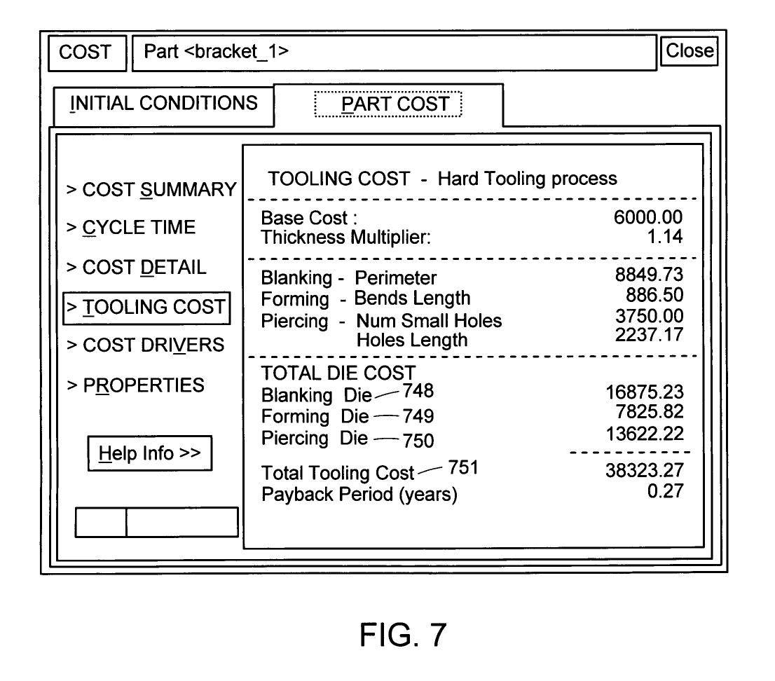

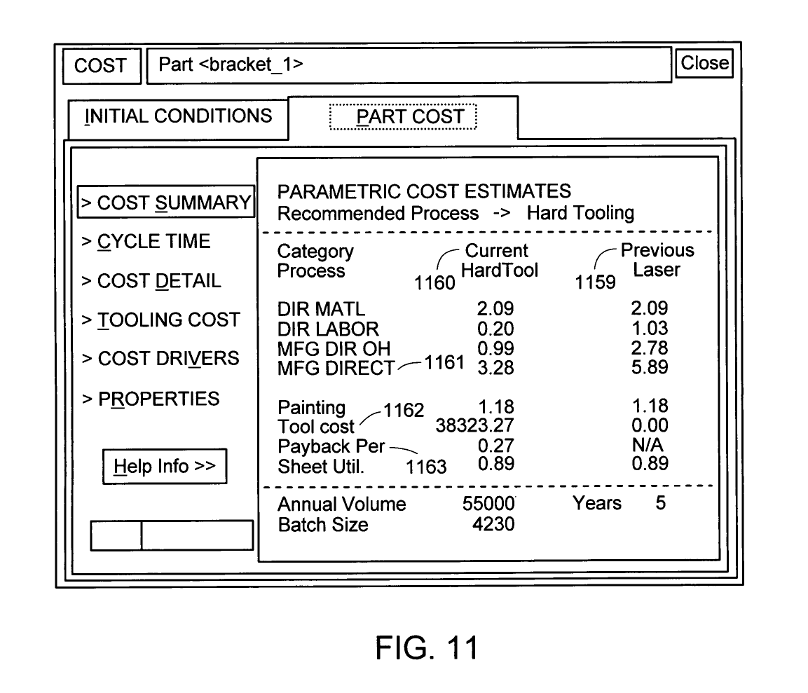

FIG. 7 shows a screen display of the Tooling Cost window, selectable from the costing dialog box 430 of FIG. 4, in accordance with an embodiment of the invention. The Tooling Cost window of FIG. 7 displays the cost of tooling. This is either the up-front investment in special purpose tooling or costs associated with expendable tooling. For example, if the part is to be manufactured using stamping dies, the tooling cost will present the cost of the die set. FIG. 7 shows the cost of each die required to manufacture the bracket part of FIG. 4: the blanking die 748 to cut the outer shape from the sheet would cost $16,875; the forming die 749 required to create the bend would cost about $7,825; and the piercing die 750 to cut the internal slot and hole features would cost $13,622; with a total tooling investment 751 of $38,323. This total is also presented in the default Cost Summary window 431 of FIG. 4, as illustrated in FIG. 11 (discussed below).

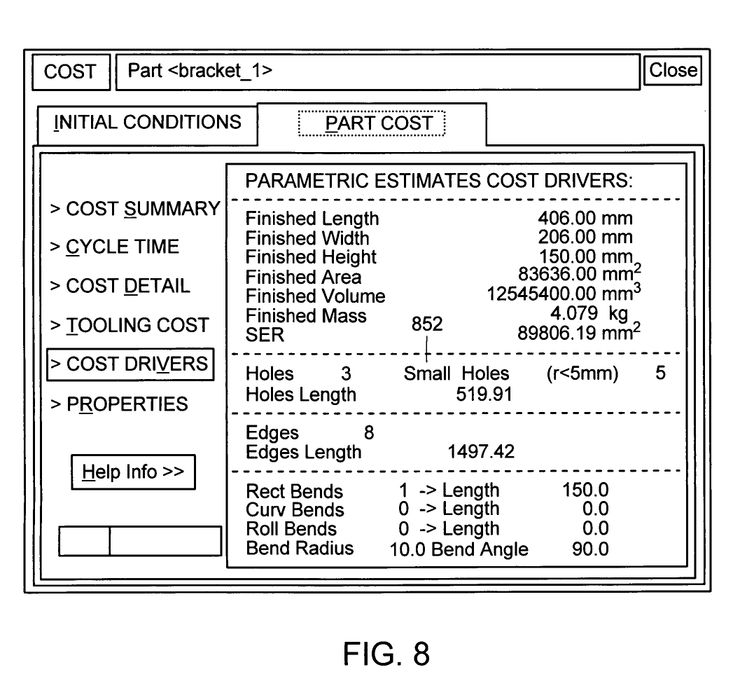

FIG. 8 shows a screen display of the Cost Drivers window, selectable from the costing dialog box 430 of FIG. 4, in accordance with an embodiment of the invention. The cost drivers are manufacturing features extracted by the feature extraction algorithms, as discussed with reference to FIG. 2. These features ‘drive’ the cost and are used by the process cost model equations of the optimizer 219 of FIG. 2 to calculate the cycle times 543 and incentive times 544 of FIG. 5. In some cases, the number of features is the cost driver (such as number of holes, edges, and different types of bends, etc.); and in other cases, measurable parameters of the feature may be a cost driver (such as perimeter length, part volume, surface area, etc.). In an embodiment according to the invention, feature extraction algorithms distinguish true manufacturing features—that is, features that directly effect cycle time and cost computation. For example, “Small Holes” 852 are holes less that 5 mm in diameter, the size below which the laser needs to make a step change in cut speed. As another example, the feature extracting algorithms might identify collinear “bends” that can be completed by one action of the bend brake.

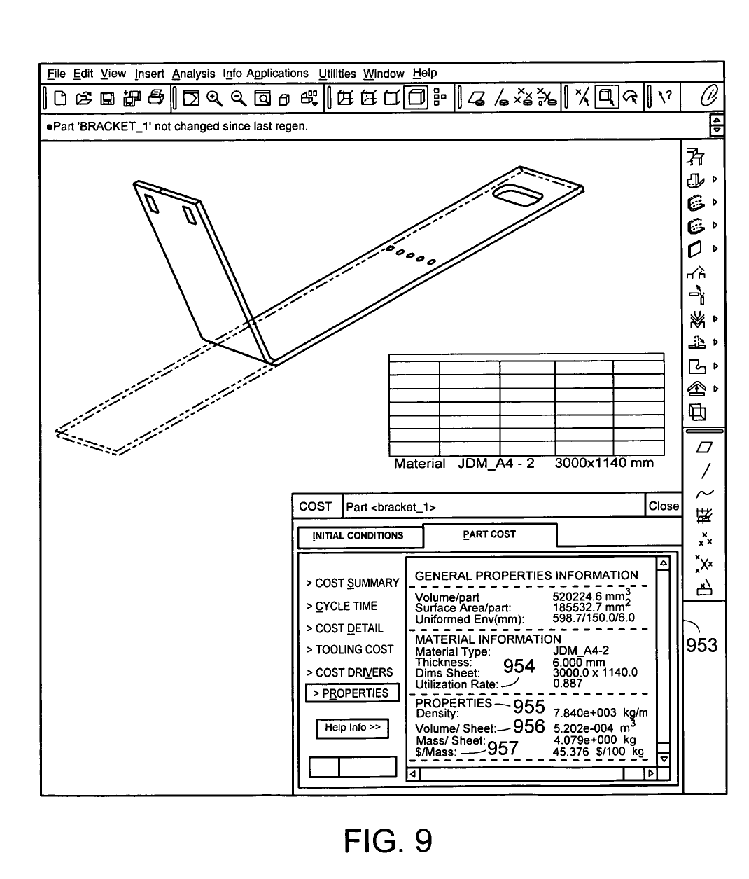

FIG. 9 shows a screen display of the Properties window 953, selectable from the costing dialog box 430 of FIG. 4, in accordance with an embodiment of the invention. The Properties window 953 provides property information that is primarily used to calculate the cost of raw material and any secondary operations, such as painting. Selecting the properties window in sheet metal mode superimposes the flat or blank form onto the part and shows how the parts will nest on the sheet. The percentage utilization 954 is displayed in the window, and is available to the designer for maximizing the number of parts per sheet. In accordance with an embodiment of the invention, material stock may be automatically selected to achieve the lowest cost per part. The company's stock raw material specifications 955, standard sheet sizes 956 and cost per mass 957 may be viewed by the user and used to help improve design decisions to give economic design solutions.

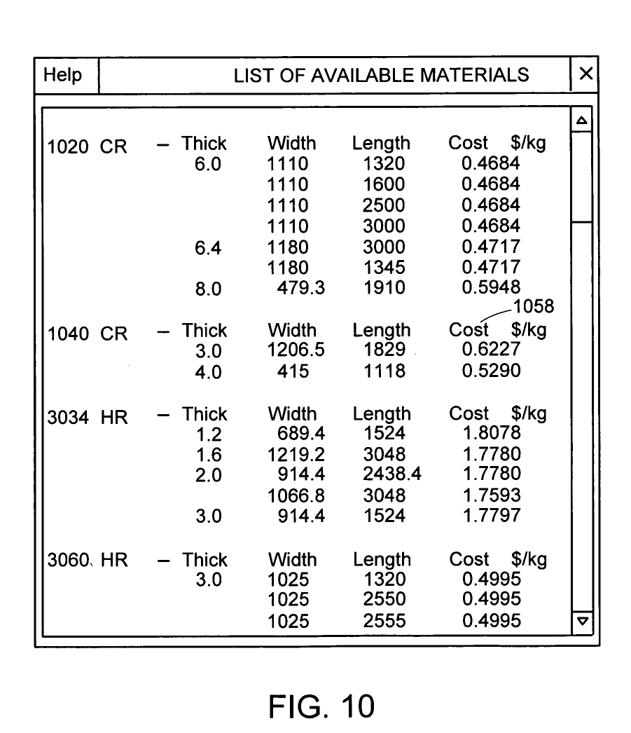

FIG. 10 shows a screen display of a stock material list, accessible through a Help screen, in accordance with an embodiment of the invention. As can be seen, the cost per kilogram 1058 varies considerably and is not directly proportional to thickness. It is influenced heavily by material type and purchasing volume. Large volume discounts are available from raw material suppliers in this market. Rationalization of stock type, sizes and thicknesses by the company can help to reduce costs significantly. An embodiment according to the invention provides a designer with the ability to optimize material cost, using both graphical and numerical information. Using an embodiment according to the invention, a designer has at his fingertips visual and numerical information for powerful “what-if” analysis. Small changes to geometry can provide for more efficient use of material, and have dramatic effects on manufacturing cost.

An embodiment according to the invention also provides an important vehicle for hard-tooling versus soft-tooling decision making, plus associated cash flow and investment risk analysis. FIG. 11 shows a view of the Cost Summary window of FIG. 4, following a change to estimated production volume, in accordance with an embodiment of the invention. The new screen capture of FIG. 11 shows the result of increasing the annual production volume from 5,500 units to 55,000 units over a five year product life. The recommended process has now changed from a soft-tooling routing incorporating a “Laser” 1159 to “Hard Tooling” 1160, a stamping die set. This decision point may be made on payback period or amortization over the predicted product life. As shown in FIG. 11, the Manufacturing Direct cost per piece 1161 has gone from $5.89 to $3.28 by utilizing a stamping die set. The die set investment 1162 is $38,323, but pays for itself 1163 in 0.27 of a year (approximately three months) at these volumes. Depending on the likelihood of meeting market forecasts and other factors such as the company's cash flow situation, the decision to hard tool may be overridden. In one embodiment according to the invention, a payback period of less than two years will result in a recommendation to use hard-tooling, although other payback periods may be specified.

A designer using an embodiment according to the invention interactively learns how design decisions affect costs. The designer may explore different processes and materials and perform a number of “what-if” analyses. Many simple design decisions, such as material thickness and type, are primarily driven by functionality; however, there are always many alternative, fully functional design approaches that may or may not have a large impact on cost. Achieving ‘maximum strength with minimum material’ is a common design philosophy today, usually because material volume is relatively easy to measure. In many cases, however, a minimum material condition does not provide the most economic design. By contrast, an embodiment according to the invention provides a tool to allow ‘maximum strength for minimum cost’ optimization, which is usually a more direct approach to ultimately achieving the desired product design result.

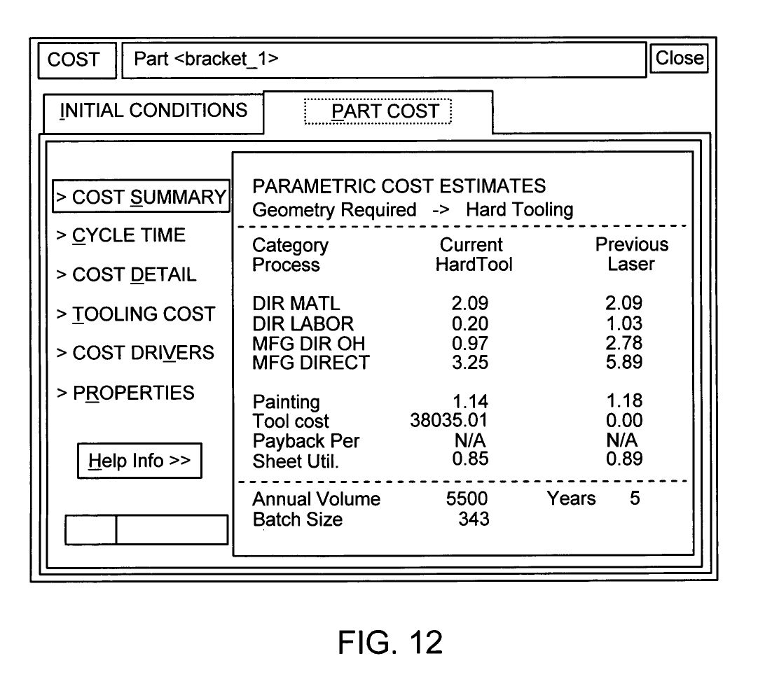

An embodiment according to the invention also warns the user of geometry that may be forcing a higher cost processing approach. For example, FIG. 12 is a window showing the result of increasing the bend radius of the bracket shown in FIG. 4 from 10 mm to 60 mm, in accordance with an embodiment of the invention. A soft tool process such as a bend brake is no longer able to create the bend radius. As shown in the dialog box of FIG. 12, hard tooling is now “geometry required”; the designer must decide whether the need for hard tooling can be justified. In some cases, the designer will be unaware of the effects of such design details; in others, the designer may wish to explore the effect on cost before making the final decision.

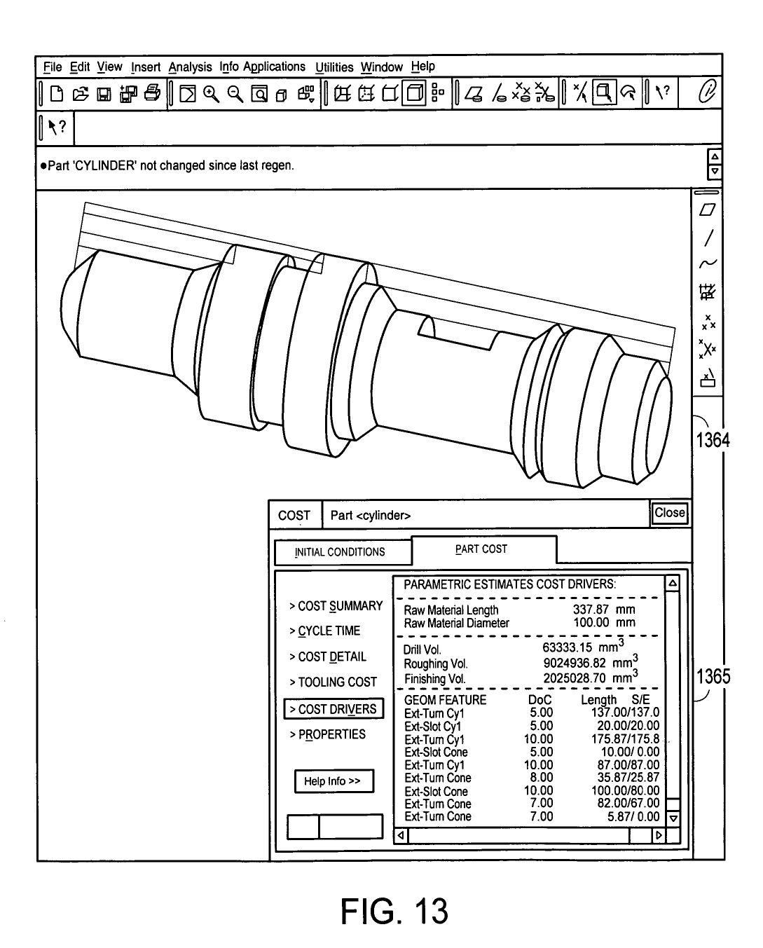

FIG. 13 shows the graphical superposition of tool path cost drivers 1364, selected by a cost optimization algorithm, onto a CAD model, in accordance with an embodiment of the invention. Such a graphical representation of the selected cost drivers may be useful, for example, in machining, where multiple material removal approaches are possible. Simultaneously, the processing parameters such as speeds, feed, and depths of cut may be numerically displayed in the associated dialog box 1365.

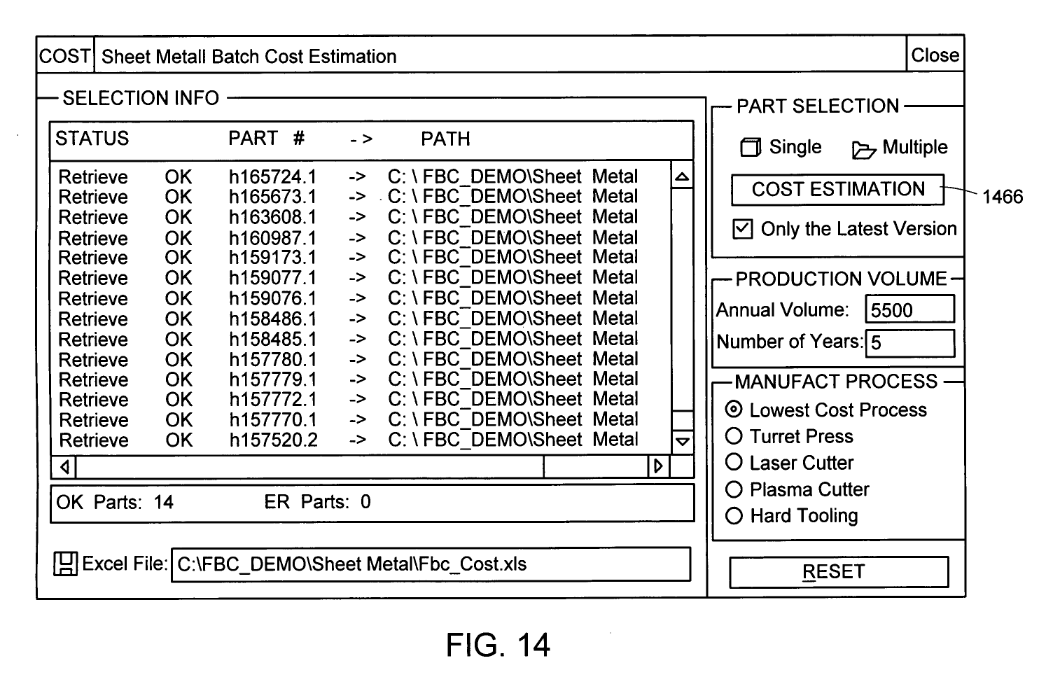

An embodiment according to the invention, in addition to providing the manufacturing cost for an individual part to the design function 101 of an enterprise (see FIG. 1), as illustrated by the screen displays of the preceding figures, may also obtain manufacturing process cost information for multiple parts, for the manufacturing function 106. FIG. 14 shows a user interface dialog box for a multiple part mode of operation, called Batch Mode, in accordance with an embodiment of the invention. In FIG. 14, a cost estimation button 1466 invokes an automatic high-speed process to open each part, determine its lowest cost routing (if desired), and estimate manufacturing cost. The cost summary information for each part may then be exported into a spreadsheet, such as Excel, for interim design reviews, project cost roll ups, etc.

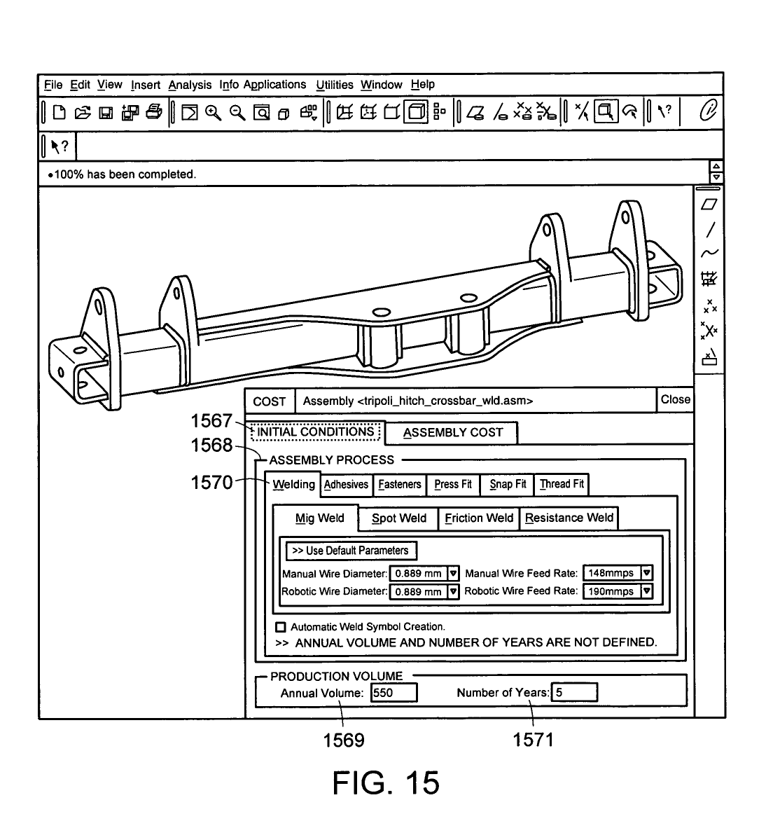

FIG. 15 is a screen display illustrating use of an assembly mode of operation, in accordance with an embodiment of the invention. In assembly mode, assembly process cost is computed and presented to the user. FIG. 15 shows the initial conditions window 1567 within the assembly mode. In this window, the desired assembly process 1568 and assembly volume is selected from a range of possible processes. The tabs 1570 show Welding, Adhesives, Fasteners, Press Fit, etc. and sub-processes for each, such as Mig welding, Spot welding, Friction welding, and Resistance welding for welding processes. Also within this window, the production volume 1569 and number of years 1571 of predicted product life is inserted by the user.

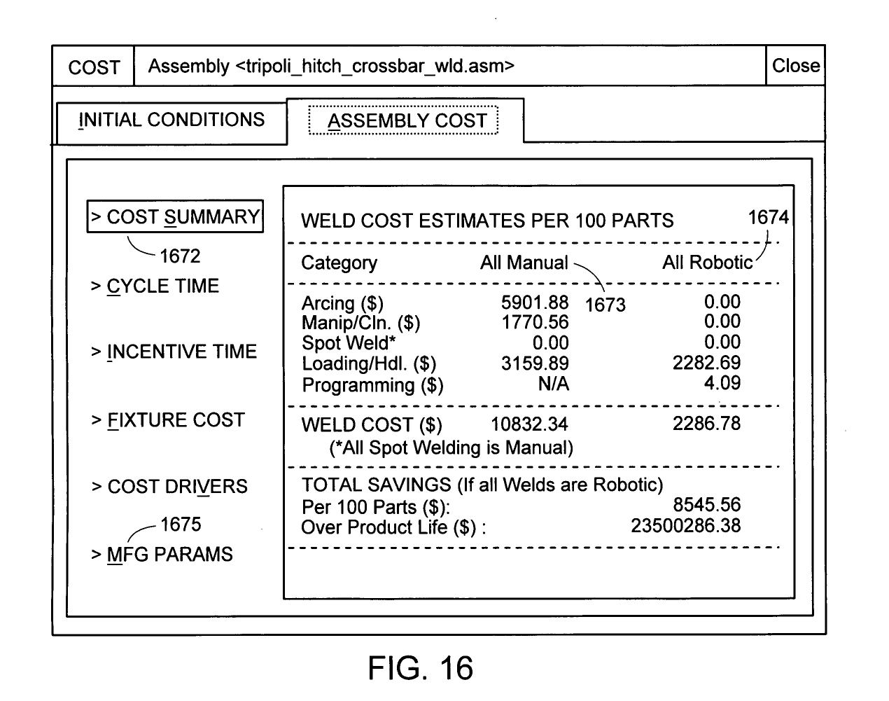

FIG. 16 shows a Cost Summary window 1672 within an assembly mode dialog box, in accordance with an embodiment of the invention. The system rapidly extracts the required cost drivers and presents the results of the cost analysis to the user. In the example of FIG. 16, the CAD system has been used to assemble a number of parts and then add the required welds. The assembly cost window shows the costs for both manual 1673 and robotic 1674 Mig welding. More details regarding specific cost drivers and useful outputs, such as welding wire consumption, are shown by clicking on the other tabs (such as tab 1675) shown on the left hand side of the dialog box of FIG. 16.

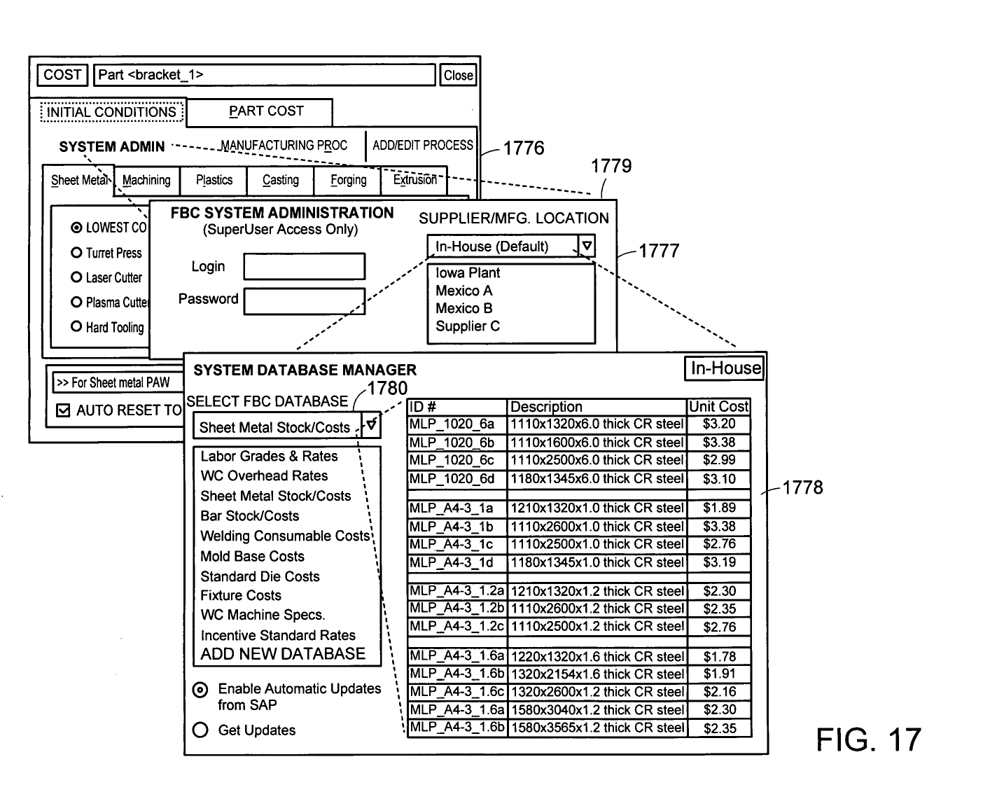

FIG. 17 shows a system administrator interface, according to an embodiment of the invention. This embodiment provides the advantage of allowing an enterprise to customize its cost estimates. Many enterprise software packages have disappointed customers, not because of their functionality, but because of their difficulty to implement and customize. A traditional in-house costing system, such as Activity Based Costing (ABC), requires a large amount of customization work to capture the specifics of each manufacturing facility. By contrast, an embodiment according to the present invention combines feature extraction, from the CAD geometry and material database, with mostly mechanistic process models, as opposed to the empirical regressions performed by other costing systems. The routing of parts and calculation of times therefore simulates the actual manufacturing process. For example, a laser machine takes a given amount of time to burn features in a given thickness of sheet metal, depending on the laser's wattage. Whether the machine is in Illinois, Mexico, or China, it will take the same time to burn a given part design. However, the parameters that do vary between enterprise facilities/factories, and between different enterprises, are the cost variables that translate physical manufacturing times into cost. These parameters include machine types/powers, wage rates, depreciation rates, overhead rates, and material prices. All of this information is normally available from existing company records, and it is now possible, using an embodiment according to the invention, to overlay this information onto time-based process models. Previously, one of the most difficult obstacles to making a good cost estimate was that the information needed for the calculation was scattered throughout many separate functions in a company. An embodiment according to the present invention solves this problem by aggregating the data across an enterprise. Instead of using ad hoc and outdated information, estimators across an enterprise have access to the latest cost data.

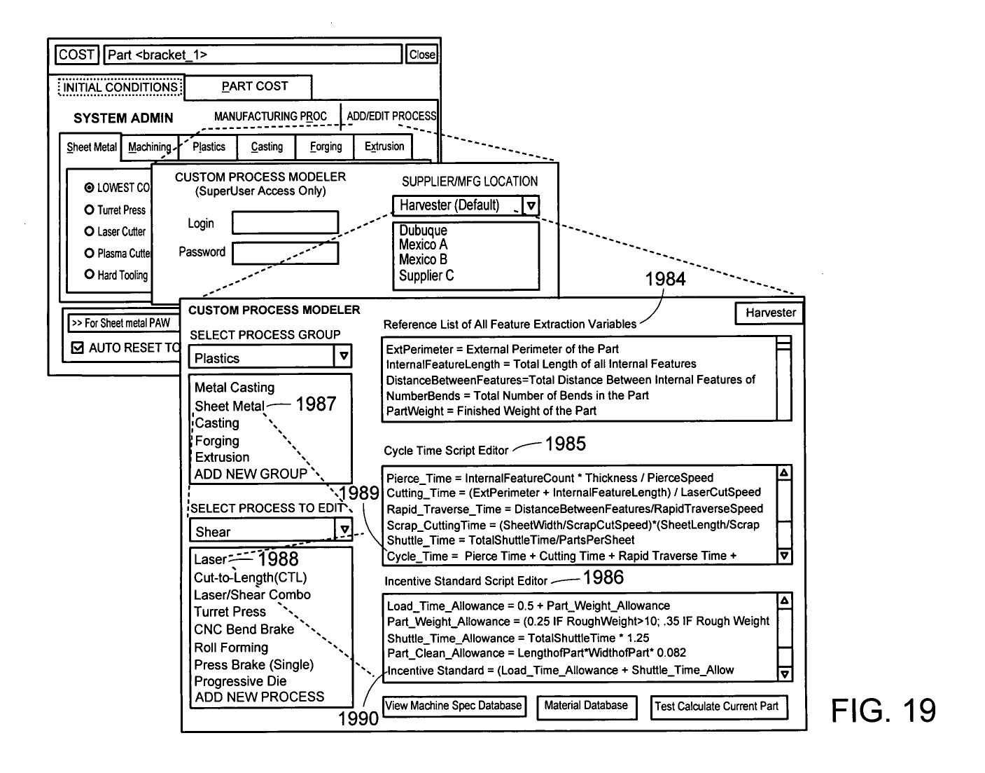

The interface of the embodiment of FIG. 17 provides access to the customer specific cost database, which may be used, for example, as the customization interface 114 of the embodiment of FIG. 1. FIG. 17 shows three levels 1776-1778 of the interface overlaid to show usage by the operator. First, in level 1777, the user must provide login and password information to ensure that he or she is authorized to add or update information to the database. The embodiment of FIG. 17 allows the user to select the “Supplier/Mfg. Location” 1779. Unlike existing systems, an embodiment according to the present invention is not restricted to just one factory, but may be customized to each plant at which it makes parts in-house, and for each supplier from which the customer purchases parts. The system administrator interface of FIG. 19 can be populated by an engineer who is an expert in cost, and can also be linked to the company's enterprise resource planning system (ERP), product lifecycle management system (PLM), or to proprietary company files or database structures. Maintenance of the system is simplified, because as cost assumptions change, the database changes automatically. Once populated, the information can be used by hundreds or thousands of users across an enterprise using a system according to an embodiment of the invention. The front level dialog box 1778 of FIG. 17 shows an example sheet metal stock list and associated costs. The sheet metal stock listed has been selected from the pull down list 1780. The pull down menu 1780 includes all of the cost database records, including labor grades and rates, work center overhead rates, bar stock costs, welding consumable costs, mold base costs, and work center machine specifics.

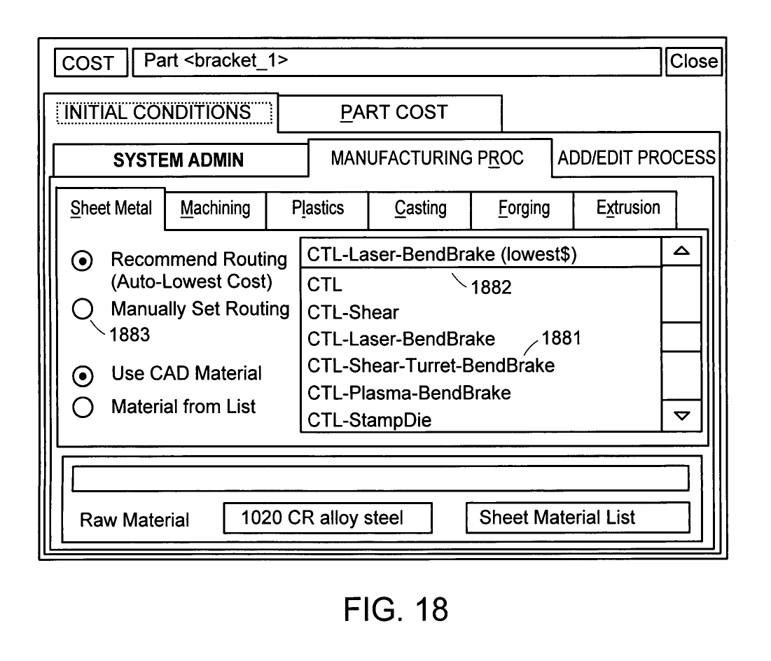

FIG. 18 shows a user interface for defining process routings, in accordance with an embodiment of the invention. Such an interface provides the ability to define the allowable sequences of processes or routings that run in a company's factory or at their suppliers' factories.

When used by the design function 101 (of FIG. 1) of the enterprise, during the concept design phase, a system according to an embodiment of the invention automatically determines which routings are appropriate for a given design, by analyzing the design using each allowable routing, and finding the lowest cost routing. However, the interface of FIG. 18 may also be used by the manufacturing function 106 (of FIG. 1), or another function of the enterprise, to define allowable routings using a scripting language or icon-based GUI. For example, in the embodiment shown in FIG. 18, the script 1881 “CTL-Shear-Turret-Bendbrade” identifies a process routing that starts with the cut to length process (CTL), then moves on to a shear process, followed by a turret press, and finishing with a bend brake operation. The “CTL-Laser Bendbrake” routing 1882 is identified as the lowest cost routing; however, if the user desires, he or she may override this optimization process and select a specific alternative routing. Radio buttons 1883 allow selection of this mode, which may be desirable for a number of reasons, for example for use by the design function 101 when capacity constraints are identified. The interface of FIG. 18 is also used (for example, by the manufacturing function 106), to define allowable routings or preferred routings within a company or supplier. In administrator mode, the sequence can be entered into the routings database using a scripting language, for example via costing interpreter 225 of FIG. 2.

When used by a purchasing function (such as function 107 of FIG. 1), the embodiment of FIG. 18 may be used as a purchasing interface, in order to perform a “should-cost” analysis. In this context, the purchasing function uses the interface of FIG. 18 to define sequences of processes or routings that are known or believed to be used at the factories of an enterprise's suppliers. A system according to an embodiment of the invention is then able to determine what a part from the supplier should cost the enterprise to buy from the supplier, by giving the purchasing function an estimate of the supplier's cost in manufacturing the part.

FIG. 19 shows a Custom Process Modeler, according to an embodiment of the invention. In the Modeler of FIG. 19, a user (such as a member of the manufacturing function 106 of FIG. 1) is able to define and modify the time-based cost models, or the equations that translate time into cost. The interface of FIG. 19 thus allows an embodiment according to the invention to automatically extract complex feature information directly from the solid model of a part, and use this information to calculate manufacturing cost. The embodiment of FIG. 19 identifies how the user has direct access to the “Reference List of All Extraction Variables” 1984. The reference list 1984 contains all of the cost driver features that are available to the user from the solid model, each time that a model regeneration occurs. Using these variables in the scripting language in the “Cycle Time Script Editor” window 1985 and the “Incentive Time Script Editor” window 1986, the operator can define how cycle times and incentive standard times, respectively, are calculated for a particular process. Direct labor costs may be calculated from these time-based models. The scripting language of FIG. 19 allows the use of mathematical functions, as well as its own constants, variables, and tables. In this way, the administrator or cost supervisor of the manufacturing function 106 of FIG. 1 (or another function in the enterprise) has the ability to modify existing process models or create new models. In the example shown in FIG. 19, a sheet metal process group 1987 has been selected and from this, a laser process model 1988 identified. The scripts show how “Cycle_Time” 1989 is the sum of pierce time, cutting time and rapid traverse time. Each of these times has equations in the Cycle Time Script Editor 1985, defined with extracted geometric cost drivers. Similarly, the “Incentive Standard Times” 1990 are defined by equations. These are the miscellaneous times for loading and unloading the machine and performing other tasks that incur operator time and therefore cost. The two times 1989 and 1990 added together provide the total labor time, from which labor cost may be calculated by multiplying by the labor rate. By providing the ability to customize manufacturing processes, the embodiment of FIG. 19 allows an enterprise to cater to all of its cost model needs.

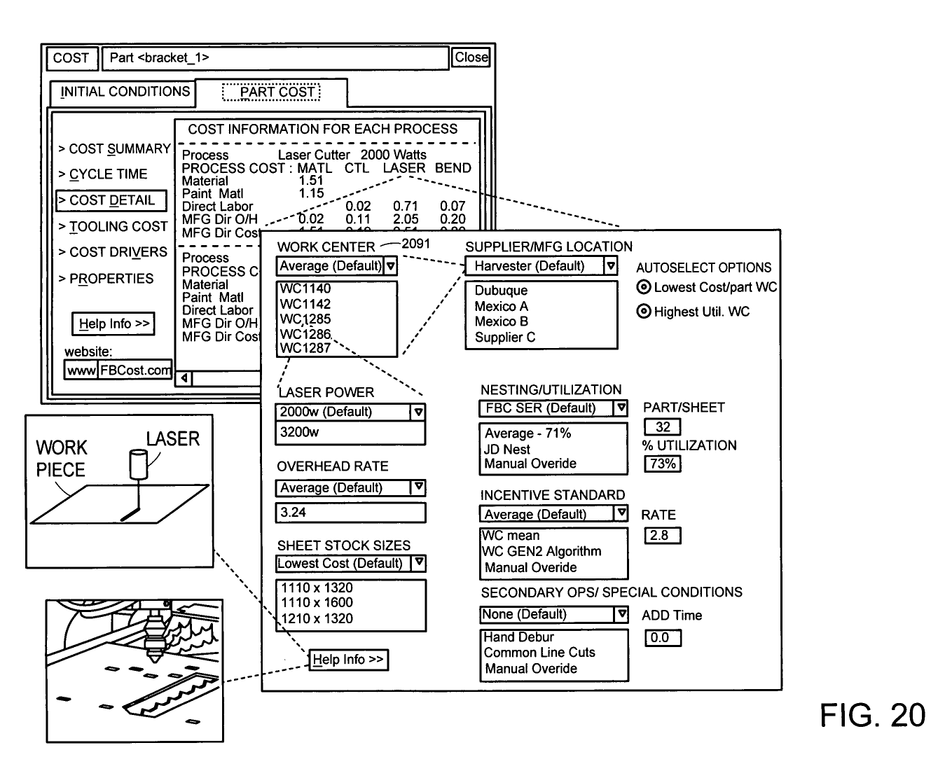

FIG. 20 shows an interface for the manufacturing function 106 of FIG. 1, in accordance with an embodiment of the invention. As a cost estimation tool for the designer, an embodiment according to the invention utilizes average rates to convert time to cost, while the designer creates the part model. As a costing tool for the manufacturing or cost engineer, there is no need for real time interaction with the CAD model. At this point in the product development process, the manufacturing details for the part are being determined. An embodiment according to the invention uses an integrated methodology, whereby enterprise functions can turn cost estimates into actual costs. Design cost estimates are refined with more user input to calculate exact manufacturing floor costs. In the manufacturing interface of FIG. 20, the user selects the specific routing that a part follows. The user can select the individual work center 2091 and the machine in the work center for each step in the routing. The interface automatically guides the user by showing which work centers are available in each factory and routing step, which materials and machines are available in each work center, and so on. By using the interface of FIG. 20, the user can get an actual manufacturing cost in a few minutes, rather than going through the arduous process of pilot runs and statistical timing studies, as used by some existing costing systems.

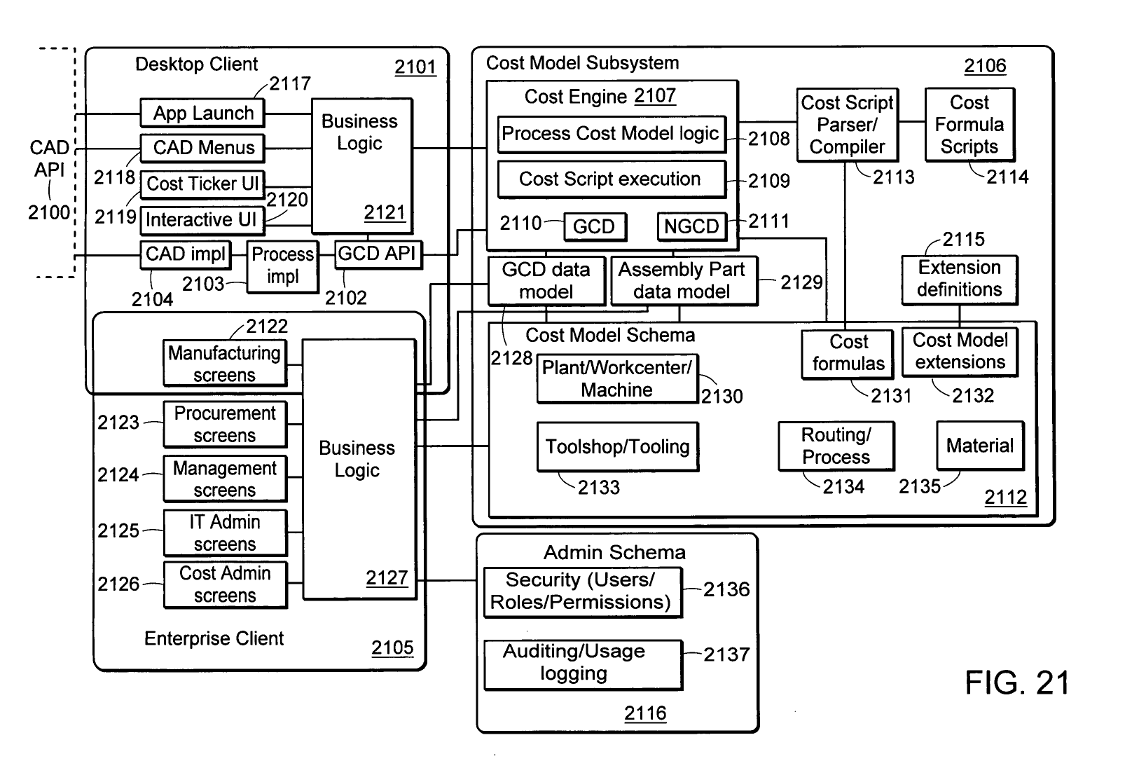

FIG. 21 is a block diagram summarizing components of an embodiment according to the invention that includes an enterprise client subsystem 2105. In the embodiment of FIG. 21, a CAD API 2100 interfaces with a desktop client subsystem 2101, which includes components for use by design and manufacturing functions of an enterprise, in order to interact in real-time with an active CAD session. The desktop client subsystem 2101 includes a Geometric Cost Driver (GCD) API 2102, which is an interface for extraction of geometry/feature information from a three-dimensional model; a Process Implementation 2103, which is an implementation of the GCD API 2102 for a particular manufacturing process; and a CAD Implementation 2104, which is an implementation of core feature-based costing libraries, permitting interaction with a particular CAD tool. The desktop client subsystem 2101 also includes an application launch unit 2117, CAD menus 2118, a cost ticker user interface 2119, an interactive user interface 2120, and business logic 2121. The business logic 2121 is used for real-time estimates, GCD persistence, feature overrides, and for producing virtual features.

The embodiment of FIG. 21 also includes an enterprise client subsystem 2105, which includes components for manufacturing, procurement, management, and administrative use across an enterprise. These components do not need to interact with an active CAD session. The enterprise client subsystem 2105 includes manufacturing screens 2122, procurement screens 2123, management screens 2124, IT Administration screens 2125, Cost Administration screens 2126, and business logic 2127. The business logic 2127 is used to provide cost models and estimates, assembly and part models, a geometric cost driver view, a non-geometric cost driver view and edit capability, a cost script view, a cost model data edit capability, a custom extension data view and edit capability, and IT administration functions.

Because the components of the enterprise client subsystem 2105 do not need to interact with an active CAD session, they may make use of a data architecture, in accordance with an embodiment of the invention, in which cost drivers are specified without reference to actual geometric data. Typically, a CAD program provides the geometry of a solid part, stored in a descriptive language describing the solid, which may include surfaces, vertices, coordinates, and so on. However, this data need not be accessed by the enterprise client subsystem 2105, particularly when certain functions of an enterprise do not need to interact with an active CAD session. Instead, the enterprise client 2105 may use a data architecture that defines cost drivers in terms of manufacturing attributes that are relevant to determining costs, but which are not a portion of a geometric data model. For example, for a hole feature in a part, the enterprise client subsystem 2105 may make use of data structured based on manufacturing attributes of the hole such as the diameter, location of center, length of perimeter, surface finish of edge, and tolerance of diameter. While such manufacturing attributes are relevant to determining costs, they are one step of abstraction above the actual geometric data model. Such a data architecture therefore allows the enterprise client 2105 to determine costs without reference to CAD API 2100.

The embodiment of FIG. 21 further includes a cost model subsystem 2106, which includes components related to the representation and execution of cost models. The cost model subsystem 2106 includes a cost engine 2107, which performs execution of cost models. The cost engine 2107 comprises: process cost model logic 2108, which is cost model logic for a particular manufacturing process; a cost script execution unit 2109, which provides execution capability for a given set of cost scripts or formulas, and may be extended by a given enterprise; a geometric cost driver (GCD) interface 2110, which interfaces to the geometric cost drivers; and a non-geometric cost driver (NGCD) interface 2111, which interfaces to the non-geometric cost drivers. The cost model subsystem 2106 also includes a cost script parser/compiler 2113, which prepares cost scripts and formulas for execution; sets of cost formula scripts 2114, which represent the main computational logic of each given cost model; and extension definitions 2115, which include metadata describing a given enterprise's extensions to a cost schema according to an embodiment of the invention. The cost model subsystem 2106 also includes a geometric cost driver data model 2128, and an assembly/part data model 2129.

The embodiment of FIG. 21 also includes a cost model schema subsystem 2112, which includes a data model for representation of costing entities, including customer extensions. The cost model schema subsystem 2112 may include data models relating to plants/workcenters/machines 2130, cost formulas 2131, cost model extensions 2132, toolshops and tooling 2133, routing and processes 2134, and material 2135.

The embodiment of FIG. 21 may also include an administration schema subsystem 2116, which provides a data model representing administrative constructs, including security and licensing information. The administration schema subsystem 2116 may include, for example, a security module 2136, which relates to the administration of users, roles and permissions; and an auditing and usage logging module 2137. Furthermore, it should be understood that the embodiment of FIG. 21 may include a variety of other components, such as object-data utilities, schema definition utilities, import/export utilities, GUI component libraries, and core Java utilities.

An embodiment according to the invention is capable of feeding costs directly into corporate cost systems, without error-prone manual user data entry. An embodiment according to the invention also replaces Activity Based Costing (ABC) systems with a cost system that is directly linked to design. It should be noted that an embodiment according to the invention does not have to be tied to a CAD system. Stored geometric and material information from a design engineer's last revision is extracted and stored with the design, and may be accessed directly by a manufacturing interface. Similarly, the cost information generated by the design or manufacturing engineer may be stored with the part model and the assembly model. An embodiment according to the invention provides a seamless cost analysis from early concept design through manufacturing, sales, and all stages and functions of an enterprise. In prior techniques, up-to-date cost information was often trapped with the cost estimator and the engineer that owned each specific part. It was very difficulty to cascade timely information across departments. An embodiment according to the invention alleviates this problem by rapidly determining the estimated cost of a product under development that includes a large number of manufacturable components of an enterprise's own new design; and by making such cost information accessible to, and modifiable by, many different functions within the enterprise.

While this invention has been particularly shown and described with references to preferred embodiments thereof, it will be understood by those skilled in the art that various changes in form and details may be made therein without departing from the scope of the invention encompassed by the appended claims.

1. A method for determining costs within an enterprise, the method comprising:
determining a set of cost-drivers based on characteristics of three-dimensional design data of a manufacturable component; and
providing, to a plurality of different enterprise functions, database access to cost data from any combination of: the set of cost-drivers, and a set of costs determined based on the set of cost-drivers.

2. A method according to claim 1, wherein providing the database access is performed during product development of a newly designed manufacturable component.

3. A method according to claim 1, wherein the plurality of different enterprise functions comprises a design function, a manufacturing function, a purchasing function, and a business management function.

4. A method according to claim 1, wherein providing the database access comprises providing a plurality of different cost-levels.

5. A method according to claim 4, wherein the plurality of cost-levels comprises a cost-level selected from a design cost, a manufacturing cost, and a purchasing cost.

6. A method according to claim 5, wherein the manufacturing cost comprises a cost determined based on costs of routing production of the manufacturable component to a specific manufacturing station.

7. A method according to claim 5, wherein the purchasing cost comprises a cost selected from purchasing costs for a plurality of different manufacturing plants.

8. A method according to claim 1, wherein the cost-drivers are stored in a database in association with three-dimensional computer-aided design data for the manufacturable component.

9. A method according to claim 1, wherein the cost-drivers are stored in a database independent of three-dimensional computer-aided design data for the manufacturable component.

10. A method according to claim 1, wherein providing the database access is used to perform a should-cost analysis for a design project comprising a plurality of manufacturable components.

11. A method according to claim 1, further comprising:
initiating a cost estimation cycle with each design change in the three-dimensional design data of the manufacturable component.

12. A method according to claim 1, wherein determining the set of cost drivers comprises using a geometric feature extraction algorithm.

13. A method according to claim 1, further comprising:
determining a set of acceptable manufacturing process routings for the manufacturable component;
determining a lowest cost routing, of the set of acceptable routings; and
displaying the lowest cost routing to a user on a graphical user interface.

14. A method according to claim 1, further comprising:
using a first server to store the cost data; and
using a second server to store a set of cost models from which the cost drivers are determined.

15. A method according to claim 1, further comprising:
providing different levels of security access to the cost data, to different enterprise functions, the levels of security access comprising modify access and read-only access.

16. A method according to claim 1, further comprising:
providing an interpreter to allow a user to link cost drivers to custom cost models, used to determine the costs based on the cost drivers.

17. A method according to claim 16, wherein the interpreter uses a scripting language to link the cost drivers to the custom cost models.

18. A method according to claim 1, further comprising:
providing a comparison of tooling investments for producing the manufacturable component based on the cost data.

19. A method according to claim 1, further comprising:
graphically superimposing a representation of the set of cost-drivers onto the three-dimensional design data.

20. A method according to claim 1, further comprising:
providing a manufacturing cost for an assembly of a plurality of manufacturable components, wherein the manufacturing cost for each manufacturable component of the assembly is determined using cost-drivers based on three-dimensional design data of each such manufacturable component.

21. A method according to claim 1, wherein providing the database access comprises providing cost data, to at least some of the plurality of different enterprise functions, that is based on manufacturing attributes specified without direct reference to a geometric model of the manufacturable component.

22. A computer system for determining costs within an enterprise, the system comprising:
a database comprising a set of stored cost-drivers determined based on characteristics of three-dimensional design data of a manufacturable component; and
a network capable of providing, to a plurality of different enterprise functions, access to cost data from any combination of: the set of cost drivers, and a set of costs determined based on the set of cost-drivers.

23. A computer system according to claim 22, the system comprising:
a design interface, for providing the database access to a design function;
a manufacturing interface, for providing the database access to a manufacturing function;
a purchasing interface, for providing the database access to a purchasing function; and
a management interface, for providing the database access to a business management function.

24. A computer system according to claim 22, the system comprising:
a customization interface, for allowing a user to determine cost data based on costs of routing production of the manufacturable component to one of a plurality of different manufacturing plants.

25. A computer system according to claim 23, wherein the manufacturing interface allows a user to determine a cost based on costs of routing production of the manufacturable component to a specific manufacturing station.

26. A computer system according to claim 23, wherein the purchasing interface is capable of providing a should-cost analysis for a design project comprising a plurality of manufacturable components.

27. A computer system according to claim 22, wherein the database comprises three-dimensional computer-aided design data for the manufacturable component, stored in association with the cost drivers.

28. A computer system according to claim 22, wherein the database comprises three-dimensional computer-aided design data for the manufacturable component, stored independent from the cost drivers.

29. A computer system according to claim 22, the system comprising a process optimizer capable of initiating a cost estimation cycle with each design change in the three-dimensional design data of the manufacturable component.

30. A computer system according to claim 29, wherein the process optimizer is capable of determining the set of cost drivers using a geometric feature extraction algorithm.

31. A computer system according to claim 27, wherein the process optimizer is capable of:
determining a set of acceptable manufacturing process routings for the manufacturable component;
determining a lowest cost routing, of the set of acceptable routings; and
providing the lowest cost routing to a graphical user interface for display to a user.

32. A computer system according to claim 22, the system comprising:
a first server for storing the cost data; and
a second server for storing a set of cost models from which the cost drivers are determined.

33. A computer system according to claim 22, the system comprising an interpreter capable of allowing a user to link cost drivers to custom cost models, used to determine the costs based on the cost drivers.

34. A system according to claim 22, further comprising:
an assembly module for providing a manufacturing cost for an assembly of a plurality of manufacturable components, wherein the manufacturing cost for each manufacturable component of the assembly is determined using cost-drivers based on three-dimensional design data of each such manufacturable component.

35. A system according to claim 22, wherein the network is capable of providing access to the cost data, to at least some of the plurality of different enterprise functions, based on manufacturing attributes specified without direct reference to a geometric model of the manufacturable component.
